(19) United States
(12) Patent Application Publication
(10) Pub. No.: US 2012/0196270 A1
(43) Pub. Date: Aug. 2, 2012

(54) METHODS FOR PRESERVING AN ORGAN FOR TRANSPLANTATION USING A HEMOGLOBIN-CARBON MONOXIDE COMPLEX

(75) Inventors: Mark YOUNG, San Diego, CA (US); Kim D. VANDEGRIFF, San Diego, CA (US)

(73) Assignee: Sangart, Inc., San Diego, CA (US)

(21) Appl. No.: 13/363,565

(22) Filed: Feb. 1, 2012

Related U.S. Application Data
(60) Provisional application No. 61/438,832, filed on Feb. 2, 2011.

(51) Int. Cl. A01N 1/02

(52) U.S. Cl. 435/1.1

(57) ABSTRACT

The present invention relates generally to methods of preserving an organ for transplantation. Specifically, the present invention is directed towards treating an organ with a hemoglobin-carbon monoxide complex to preserve the organ before transplantation.

### CROSS-REFERENCE TO RELATED APPLICATIONS

This application is a continuation of U.S. Provisional Patent Application No. 61/438,832 entitled “Methods for Preserving an Organ For Transplantation Using a Hemoglobin-Carbon Monoxide Complex” and filed Feb. 2, 2011, the contents of which are incorporated herein in their entirety.

### TECHNICAL FIELD

The present invention relates generally to methods of preserving an organ for transplantation. Specifically, the present invention is directed towards treating an organ with a hemoglobin-carbon monoxide complex to preserve the organ before transplantation.

### BACKGROUND OF THE INVENTION

Each year, thousands of organ transplants are performed throughout the world. Of these, the kidney is the most commonly transplanted organ. According to data from the United Network for Organ Sharing, more than 400,000 kidney transplants have been performed since the first one was performed in 1954. With improved surgical techniques and immunosuppressive medications, successful kidney transplantations have continued to increase. However, the time required to harvest the organ and perform transplantation surgery has not shown significant improvement, and many kidneys are not suitable for transplantation after they are harvested because of tissue damage.

The average waiting time for a deceased donor kidney transplant is now approaching 3 years. For a heart transplant, the waiting time is approximately 18 months. Each year, more patients are placed on waiting lists than those receiving transplants, with the net result that waiting times are continuing to increase. Because the number of patients awaiting transplantation continues to increase, there is a critical need for methods to preserve donor organs for transplantation.

Organ preservation time varies depending on the organ. Most surgeons prefer to transplant a heart within 5 hours of its removal from the donor. The kidney can safely be stored for 40-50 hours after removal, but earlier transplantation is preferred. Most pancreas transplants are performed within 15 hours of removal, and liver transplantations are usually performed within 12 hours.

The removal, storage and transplantation of a solid organ from a donor alters the homeostasis of the organ. This affects the degree to which recovery of normal organ function is delayed or prevented after transplantation. The injury an organ sustains during removal, preservation and transplantation occurs primarily because of ischemia, hypothermia and reperfusion.

Hypothermia is a preferred technique of organ preservation because it is simple, does not require sophisticated expensive equipment, and allows ease of transport. With hypothermia, metabolism and degradative reactions are considerably slowed but not halted. A 10° C. decrease in temperature slows the metabolic rate by a factor of 2. Cooling an organ from 37° C. to 0° C. slows metabolism by a factor of 12-13. However, hypothermia alone is not sufficient to increase preservation time for deceased donor organs. Therefore, the organ must also be flushed with an appropriate preservation solution.

During removal and storage, organ damage occurs in two phases. The first is the warm ischemic phase and includes the time from the interruption of circulation to the donor organ (i.e., removal) to the time the organ is perfused with a hypothermic organ preservation solution. The second is the cold ischemic phase that occurs after the organ is perfused and maintained in a hypothermic state prior to transplantation into the recipient. These two phases directly affect organ cell membranes, which play a structural role for the organ cells and provide an active interface with the extracellular environment.

The stability of the membrane to chemical and water permeability depends on the integrity of the lipid bilayer and on tight control of temperature, pH and osmolarity. Lowering the temperature drastically alters the phase transition of lipids, which increases membrane permeability and contributes to cell swelling. Increased membrane permeability also leads to the release of free radicals that initiate redox signaling to initiate cell apoptosis. Consequently, many organ preservation solutions are hypertonic in order to minimize these alterations.

During transplantation, reperfusion of the organ generates more oxygen free radicals, which often causes more injury to the organ. Furthermore, reperfusion related events have been attributed to enhanced immunogenicity of the organ, which results in immunological rejection of the organ by the recipient.

To reduce organ damage during removal, storage and transplantation, collectively referred to herein as “the transplantation process”, varieties of preservation solutions have been developed and are commercially available, For example, see U.S. Pat. No. 5,082,851.

Until recently, the primary solution used for hypothermic organ preservation of the kidneys was Euro-Collins solution. Its formulation provides a hyperosmolar environment with an intracellular electrolyte composition intended to reduce cellular swelling. In combination with hypothermia, kidneys were safely stored in this solution for up to 36-48 hours before transplantation. (Groenewoud et al. 1992, Transpl. Int., 5 Suppl. 1:S429-32).

Researchers at the University of Wisconsin developed a solution, also known as Viaspan™ or “UW” solution, which simplified the practice of liver and pancreas transplantations by extending preservation times. The UW solution is based on lactobionate, raffinose, hydroxyethyl starch (“HES”) and a host of other ingredients designed to provide high-energy phosphate precursors, hydrogen-ion buffering capacity and antioxidant properties. (Faenza et al. 2001, Transplantation, 72(7):1274-7). Lactobionate, the carboxylate anion of lactobionic acid (a disaccharide formed from gluconic acid and galactose), was used in place of the glucose contained in Euro-Collins solution to provide osmotic support and prevent cellular swelling. Raffinose, a naturally occurring trisaccharide of fructose, glucose and galactose, provides additional osmotic activity and HES is a colloid that prevents an increase in the extracellular space.

Most teams that perform liver and pancreas transplantations prefer UW solution as the preservation method of choice. Both the liver and pancreas can be reliably stored for 12-18 hours, and isolated clinical cases with total cold ischemia times in excess of 30 hours have been reported. However, evidence is accumulating that cold ischemia longer than 12 hours may be associated with a higher incidence of biliary strictures.

More recent preservative solutions (e.g. Celsior™ solution, Genzyme Corporation, Cambridge, Mass.), appear to have advantages over UW solution, though results are conflicting. (Cavallari et al. 2003, Liver Transpl., 9(8):814-21). Another solution, known as the Kyoto solution, was evaluated and found to be as good as UW solution for kidney storage. Furthermore, the Kyoto solution was less viscous and stable at room temperature for as long as 3 years, and it was cost effective as compared with UW solution. (Yoshida et al. 2002, Transplantation, 74(9):1231-6).

Further, Bretschneider's HTK solution, originally developed for cardioplegia, is routinely used for liver, kidney and heart transplantation. HTK solution has been shown to be superior to Euro-Collins solution, having a lower viscosity and less leukocyte adhesion. However, no significant increases in organ storage time have been observed using HTK. (Agarwal et al. 2005, Transplant. Proc., 37:3523-6).

Simple cold storage and continuous hypothermic perfusion are two techniques of hypothermic preservation most often used. With simple cold storage, the organ is flushed with cold preservative solution and placed in a sterile bag immersed in the solution. The sterile bag is placed inside another bag that contains crushed ice. With continuous hypothermic perfusion, developed in 1967, a machine is used to continuously pump perfusion fluid through the organ. In this way, oxygen and substrates are continuously delivered to the organ, which maintains ion-pump activity and metabolism.

For kidneys, machine perfusion offers superior results compared with simple cold storage. With simple cold storage, approximately 25-30% of transplanted kidneys have delayed graft function, but with machine perfusion, this rate is reduced to less than 10%. However, the use of a perfusion machine makes transport more difficult.

Oxidative stress can be initiated by the lack of oxygen during cold preservation and ATP depletion, followed by an alteration in intracellular calcium and sodium concentrations and activation of cytotoxic enzymes. Subsequent warm reperfusion of grafts also initiates a rapid increase in the generation of reactive oxygen species, which further promotes cell damage and activates inflammatory cascades. (Freeman et al. 1982, Lab. Invest., 47: 412-426).

Carbon monoxide (“CO”) gas has previously been reported to have cytoprotective and anti-inflammatory effects against oxidative stress. (Brouard et al. 2000, J. Exp. Med., 192:1015-1026). Specifically, CO is believed to exert biological actions by inhibiting proinflammatory cytokines (e.g., TNF-α, IL-1β) and chemokines, preventing vascular constriction, and inhibiting platelet aggregation. (Fujita et al. 2001, Nat. Med., 7:598-604).

Various studies have been conducted to survey the protective effects that CO imparts to transplanted tissue undergoing oxidative stress, such as ischemia or reperfusion injury. One such study investigated CO's effects on ischemia-reperfusion induced renal injury by administering CO gas at low concentrations to rat kidney transplant models with prolonged cold storage. (New et al. 2004, Am. J. Physiol. Renal Physiol., 287: F979-F989). It was observed that CO inhalation provided significant protective effects against renal ischemia-reperfusion injury and improved the function of renal grafts. Further, other studies have investigated the role of CO in reducing infarct size of ischemic rat hearts using intravenous administration of CO-releasing molecules. (Guo et al. 2004, Am, J. Physiol. Heart Circ. Physiol., 286: H 1649-H 1653; Stein et al. 2005, J. Mol. Cell. Cardiol., 38: 127-134). It was discovered that intravenous delivery of CO provided beneficial effects without dramatic elevation of circulating CO-Hb concentrations, and that cardioprotective effects could be activated by low circulating levels of CO in the blood.

The administration of CO using hemoglobin as a carrier has also been investigated. See, for example, WO 94/22482 which describes the use of hemoglobin to deliver nonoxygen gas ligands (e.g., CO, NO and CO₂). Another heme carrier, maleimide-activated PEG conjugated to Hb, or MaIPEG-Hb, is discussed in U.S. Patent Pub. No. 2009/0082257 as a carrier for the therapeutic delivery of CO. However, the administration of a CO-Hb complex has not been proposed for preserving an organ prior to transplantation.

Consequently, there is a need for a system that can substantially extend organ preservation times and reduce reperfusion injuries through the use of a hemoglobin-based carbon monoxide carrier.

### SUMMARY OF THE INVENTION

The present invention relates generally to methods of preserving a tissue or organ for transplantation comprising the steps of: a) providing a hemoglobin-carbon monoxide (Hb-CO) complex; b) selecting a tissue or organ for transplantation; and c) treating the tissue or organ with the Hb-CO complex.

One embodiment of the present invention relates to a method wherein treating the tissue or organ with an Hb-CO complex comprises treating the tissue or organ ex vivo. In an alternative embodiment, treating the tissue or organ with an Hb-CO complex comprises treating the tissue or organ in situ.

In another embodiment of the present invention, the step of treating the tissue or organ with an Hb-CO complex comprises perfusing the tissue or organ with an Hb-CO complex. In still another embodiment, the step of treating the tissue or organ with an Hb-CO complex comprises suffusing the tissue or organ with an Hb-CO complex. In still another embodiment, the step of treating the tissue or organ with an Hb-CO complex comprises bolus administration to the tissue or organ with an Hb-CO complex. Other embodiments regarding the step of treating the tissue or organ with an Hb-CO complex may further include a combination of perfusion, suffusion and/or bolus administration to the tissue or organ with an Hb-CO complex.

In one aspect of the present invention, the hemoglobin of the Hb-CO complex comprises a pegylated hemoglobin conjugate. In one exemplary aspect, the pegylated hemoglobin conjugate further comprises maleimide polyethylene glycol conjugated hemoglobin (Mal PEG-Hb).

The methods of the present invention relate generally to the preservation of tissues and organs. In various embodiments, the tissues or organs that may be selected for treatment may include, but are not limited to, kidneys, liver, lungs, pancreas, heart, intestines and skin.

### DETAILED DESCRIPTION OF THE INVENTION

The present invention relates generally to methods of preserving an organ for transplantation. Specifically, the present invention is directed to perfusing an organ with a hemoglobin-carbon monoxide complex to preserve the organ before transplantation.

In the description that follows, a number of terms used in the field of hemoglobin research and medicine are extensively utilized. In order to provide a clear and consistent understanding of the specification and claims, including the scope to be given such terms, the following non-limiting definitions are provided.

When the terms “one,” “a” or “an” are used in this disclosure, they mean “at least one” or “one or more,” unless otherwise indicated.

The terms “activated polyalkylene oxide” or “activated PAO” as used herein refer to a PAO molecule that has at least one functional group. A functional group is a reactive moiety that interacts with free amines, sulfhydryls or carboxyl groups on a molecule to be conjugated with PAO. For example, one such functional group that reacts with free sulfhydryls is a maleimide group. Correspondingly, a functional group that reacts with free amines is a succinimide group.

The term “donor” as used herein refers to an animal (human or non-human) from whom an organ or tissue can be obtained for the purpose of transplantation to a recipient. The term “recipient” refers to an animal (human or non-human) into which an organ or tissue is transplanted.

The terms “hemoglobin” or “Hb” as used herein refer generally to the protein within red blood cells that transports oxygen. Each molecule of Hb has 4 subunits, 2 α-chain subunits and 2 β-chain subunits, which are arranged in a tetrameric structure. Each subunit also contains one heme group, which is the iron-containing center that binds the ligands O₂, NO and CO. Thus, each Hb molecule can bind up to 4 ligand molecules.

The term “MaIPEG-Hb” as used herein refers to Hb to which maleimidyl-activated PEG has been conjugated. The conjugation is performed by reacting MaIPEG with surface thiol groups (and to a lesser extent, amino groups) on the Hb to form MaIPEG-Hb. Thiol groups are found in cysteine residues present in the amino acid sequence of Hb, and can also be introduced by modifying surface amino groups to contain a thiol group.

The terms “methemoglobin” or “metHb” as used herein refer to an oxidized form of Hb that contains iron in the ferric state. MetHb does not function as a ligand carrier. The term “methemoglobin %” as used herein refers to the percentage of oxidized Hb to total Hb.

The terms “methoxy-PEG” or “mPEG” as used herein refer to PEG wherein the hydrogen of the hydroxyl terminus is replaced with a methyl (—CH₃) group,

The terms “mixture” or “mixing” as used herein refer to a mingling together of two or more substances without the occurrence of a reaction by which they would lose their individual properties.

The term “solution” refers to a liquid mixture and the term “aqueous solution” refers to a solution that contains some water and may also contain one or more other liquid substances with water to form a multi-component solution.

The terms “modified hemoglobin” or “modified Hb” as used herein refer to, but are not limited to, Hb that has been altered by a chemical reaction, such as intra- and inter-molecular crosslinking, and recombinant techniques, such that the Hb is no longer in its “native” state. As used herein, the terms “hemoglobin” or “Hb” refer to both native unmodified Hb and modified Hb, unless otherwise indicated.

The terms “organ” or “organs” as used herein refer to any anatomical part or tissue having a specific function in an animal. This also includes a portion of an organ, e.g., a lobe of a lung. Such organs include, but are not limited to, the kidney, liver, heart, intestine, pancreas and lung.

The term “oxygen affinity” as used herein refers to the avidity with which an oxygen carrier, such as Hb, binds molecular oxygen. This characteristic is defined by the oxygen equilibrium curve, which relates the degree of saturation of Hb molecules with oxygen (Y axis) with the partial pressure of oxygen (X axis). The position of this curve is denoted by the P50 value, which is the partial pressure of oxygen at which the oxygen carrier is half-saturated with oxygen, and is inversely related to oxygen affinity. Hence, the lower the P50, the higher the oxygen affinity. The oxygen affinity of whole blood (and components of whole blood, such as red blood cells and Hb) can be measured by a variety of methods known in the art. (see, e.g., Winslow, R. M. et al., J. Biol. Chem. 1977, 252:2331-37). Oxygen affinity may also be determined using a commercially available HEMOX™ Analyzer (TCS Scientific Corporation, New Hope, Pa.). (see, e.g., Vandegriff and Shrager in “Methods in Enzymology” (Everse et al., eds.) 232:460 (1994)).

The terms “polyethylene glycol” or “PEG” as used herein refer to polymers of the general chemical formula H(OCH₂CH₂)ₙ OH, also known as (α-Hydro-ω-hydroxypoly-(oxy-1, 2-ethanediyl), where “n” is greater than or equal to 4. Any PEG formulation, substituted or unsubstituted, is encompassed by this term. PEGs are commercially available in a number of formulations (e.g., Carbowax™ (Dow Chemical, Midland, MI) and Poly-G® (Arch Chemicals, Norwalk, Conn.)).

The terms “polyethylene glycol-conjugated hemoglobin,” “PEG-Hb conjugate” or “PEG-.Hb” as used herein refer to Hb to which PEG is covalently attached.

The terms “stroma-free hemoglobin” or “SFH” as used herein refer to Hb from which all red blood cell membranes have been removed.

The term “thiolation” as used herein refers to a process that increases the number of sulfhydryl groups on a molecule. For example, reacting a protein with 2-iminothiolane (“2-IT”) converts free amines on the surface of a protein to sulfhydryl groups.

The term “transplantation” as used herein refers to the process of transferring an organ or tissue from one patient to another. The term “transplantation” is defined in the art as the transfer of living tissues or cells from a donor to a recipient, with the intention of maintaining the functional integrity of the transplanted tissue or cells in the recipient (see, e.g., The Merck Manual, Berkow, Fletcher, and Beers, Eds., Merck Research Laboratories, Rahway, N.J., 1992).

The term “ex vivo administration” as used herein refers to the administration of the compositions described herein to tissues and organs that have been removed from a donor. The term “in situ administration” as used herein refers to the administration of the compositions described herein to the tissues and organs of an intact nonliving donor.

Carbon Monoxide Metabolism

Carbon monoxide (“CO”) functions as a vasodilator. CO is a colorless, odorless and tasteless gas which is formed in many chemical reactions and in the thermal or incomplete decomposition of many organic materials. In the atmosphere, the average global levels are estimated to be 0.19 parts per million (“ppm”), 90% of which comes from natural sources including ocean microorganism production, and 10% of which is generated by human activity. Thus, inhalation of even small quantities of CO is inevitable for living organisms.

Inhaled CO is potentially toxic at levels of prolonged exposure greater than 100 ppm. This is because CO binds to Hb in circulation to form carboxyhemoglobin, which prevents the hemoglobin from carrying oxygen. This causes an overall reduction in the oxygen-carrying capacity of the blood and leads to hypoxia. Symptoms of low level exposure may include, for example, headaches, vertigo and flu-like symptoms. High levels of exposure can be toxic to the central nervous system and the heart, and can even cause death.

There are now numerous studies documenting the beneficial effects of inhaled CO in animal models, Such studies include, for example, the use of CO in the treatment of sickle cell disease (Belcher, J. D. et al., 2006, J. Clin. Invest. 116:808-816), the heart (Akamatsu, Y. et al., 2004, FASEB J. 18:771-772) and also in the prevention of organ damage (Neto, J. S. et al., 2004, Am. J. Physiol. Heart Circ. Physiol. 289:H542-548; Kohmoto, J. et al., 2007, Am. J. Transplant, 7:2279-2290; Zuckerbraun, B. S. et al., 2005, Shock 23:527-532; Ryter, S. W. et al., 2007, Antioxid, Redox Signal 9:2157-2173; and Fujimoto, H. et al., 2004, Arterioscler. Thromb. Vasc, Biol. 24:1848-1854).

Most of these studies utilized inhaled CO at levels between 250-1000 ppm for extended periods, and achieved carboxyhemoglobin saturation near 20% of total Hb. These levels of carboxyhemoglobin are considered toxic during chronic exposure (Mirza, A. et al., 2005, Toxicol, Sci. 85:976-982; Durante, W. et al., 2006, J. Cell. Mol. Med. 10:672-686; and Gautier, M. et al., 2007, Am. J. Heart Circ. Physiol. 293:H1046-H1052) and, at the very least, will engage acute compensatory changes due to hypoxia when arterial oxygen saturation (“SaO₂”) falls below 90% (Koehler, R. C. et al., 1982, Am. J. Physiol. 243:H27-H32). The dose-dependency of CO-mediated cytoprotection is not completely understood.

It has been demonstrated that PAO-Hbs are effective CO carriers. (See Vandegriff, K., et al,, 2008, Br. Journal of Pharmacol. 254:1649-1661). Specifically, MalPEG-Hb conjugates to which CO is bound have overall CO equilibrium constants similar to that of unmodified Hb.

Hemoglobin Based Carbon Monoxide Carrier

In previous studies, it was observed that the molecular size of surface modified hemoglobin has to be large enough to avoid being cleared by the kidneys and to achieve the desired circulation half-life. Blumenstein, J. et al., determined that this could be achieved at, or above, a molecular weight of 84,000 Daltons (“Da”) (“Blood Substitutes and Plasma Expanders,” Alan R. Liss, editors, New York, N.Y., pages 205-212 (1978)). In that study, the authors conjugated dextran of varying molecular weight to Hb. They reported that a conjugate of Hb (with a molecular weight of 64,000 Da) and dextran (having a molecular weight of 20,000 Da) “was cleared slowly from the circulation and negligibly through the kidneys.” Further, it was observed that increasing the molecular weight above 84,000 Da did not significantly alter these clearance curves. Accordingly, in the practice of the present invention, the surface modified Hb has a molecular weight of greater than 64,000 Da.

a. Hemoglobin

The Hb utilized in the present methods is not limited by its source and can be derived from humans or animals, or from recombinant techniques. It may be either native (unmodified) or modified, or recombinantly engineered. Human α- and βglobin genes have both been cloned and sequenced (Liebhaber, S. A. et al., PNAS 1980, 77:7054-7058; Marotta, C. A. et al., J. Biol. Chem, 1977, 353: 5040-5053 (β-globin cDNA)). In addition, many recombinantly modified Hbs have now been produced using site-directed mutagenesis, although these “mutant” Hb varieties were reported to have undesirably high oxygen affinities (e.g., Nagai, K. et al., PNAS 1985, 82:7252-7255). Preferably, the Hb is stroma free and endotoxin free,

b. Organic Polymers

For surface decorated hemoglobin, suitable polyalkylene oxide polymers include, polyethylene oxide (—(CH₂ CH₂ O)ₙ—), polypropylene oxide (—(CH(CH₃)CH₂ O)ₙ—) and a polyethylene/polypropylene oxide copolymer (—(CH₂ CH₂ O)ₙ—(CH(CH₃)CH₂ O)ₙ—). Other straight, branched chain and optionally substituted synthetic polymers that would be suitable in the practice of the present invention are well known in the medical field.

The most common PAO presently used to modify the surface of Hb is PEG because of its pharmaceutical acceptability and commercial availability. In addition, PEG is available in a variety of molecular weights based on the number of repeating subunits of ethylene oxide (i.e. —OCH₂CH₂—) within the molecule. PEG formulations are usually followed by a number that corresponds to their average molecular weight. For example, PEG-200 has an average molecular weight of 200 Da and may have a molecular weight range of 190-210 Da.

c. Conjugation

Conjugation of organic polymers to Hb is described in the literature. In one embodiment, the organic polymers are attached via sulfhydryl groups on the Hb. One method to increase the number of available conjugation sites on Hb is to introduce sulfhydryl groups (“—SH”), which tend to be more reactive with MaIPEG than free amines. A variety of methods are known in the art for thiolation of proteins. These include, for example, thiolating free amine containing residues of the protein by reaction with succinimidyl 3-(2-pyridyldithio) propionate followed by reduction of the 3-(2-pyridyldithio) propionyl conjugate with dithiothreitol (“DTT”), or tris(2-carboxyethyl)phosphine (“TCEP”),

Amines can also be indirectly thiolated by reaction with succinimidyl acetylthioacetate, followed by removal of the acetyl group with 50 mM hydroxylamine, or hydrazine, at near-neutral pH. In addition, 2-iminothiolane (2-IT) can be used to convert free amine groups into thiol groups. In one embodiment, the thiolation reaction is carried out at a pH of between 7 to 9, which is below the pH at which the 2-IT hydrolyzes significantly before the reaction is completed and also below the pKa of lysine to optimize the extent of the reaction.

d. Complexation

Complexation of the Hb with CO is accomplished using any known method for forming a complex of O₂ and Hb, simply by substituting CO instead of O₂ as the ligand. For example, CO gas can be introduced into a solution of Hb, and since Hb has a higher affinity for CO than for O₂, it will readily replace the O₂ as the ligand.

Ligand Affinity

In one embodiment, the CO carrier is a PEG-Hb conjugate, in which case the PEG-Hb conjugate may have an oxygen affinity greater than whole blood, and more specifically, twice or even thrice that of whole blood. Stated differently, the PEG-Hb may have an oxygen affinity greater than that of stroma free hemoglobin (SFH), when measured under the same conditions. This means that the PEG-Hb conjugate will generally have a P50 less than 10 millimeters of mercury (mmHg), but greater than 3 mmHg. SFH has a p50 of approximately 15 mmHg at 37° C., pH 7.4, whereas the p50 for whole blood is approximately 28 mmHg under the same conditions. It was suggested that increasing oxygen affinity of a hemoglobin-based oxygen carrier (“HBOC”), and thereby lowering the p50, could enhance delivery of oxygen to tissues, but that an oxygen affinity lower than that of SFH would not be acceptable. See Winslow, R. M. et al., in “Advances in Blood Substitutes” (1997), Birkauser, eds. Boston, Mass., at page 167, and U.S. Pat. No. 6,054,427. This suggestion contradicts the widely held belief that HBOCs should have lower oxygen affinities, and specifically p50s that approximate that of whole blood. Hence, many researchers have used pyridoxyl phosphate to raise the p50 of SFH from 10 mmHg to approximately 20-22 mmHg, since pyridoxylated Hb more readily releases oxygen when compared to SFH.

There are many different scientific approaches to manufacturing HBOCs with high oxygen affinity (i.e. those with p50s less than SFH). For example, studies have identified the amino acid residues that play an important role in oxygen affinity, such as β93 cysteine. Because of these findings, site-directed mutagenesis can now be easily carried out to manipulate oxygen affinity to the desired level (see, e.g., U.S. Pat. No. 5,661,124). The β93 cysteine residue is located immediately adjacent to the proximal β92 histidine residue, which is the only residue in the β-subunit directly coordinated to the heme iron. Attachment of the rigid, bulky maleimide group to the β93 cysteine displaces a salt bridge that normally stabilizes the low-affinity T-state Hb conformation (Perutz M. F. et al., Biochemistry 1974, 13:2163-2173). This shifts the quaternary conformation towards the R state, resulting in higher O₂ affinity (Imai, K. et al., Biochemistry 1973, 12:798-807). Many other approaches are discussed in U.S. Pat. No. 6,054,427.

Formulation for Administration

The CO-Hb complex of the present invention is formulated in an aqueous diluent that is suitable for ex vivo administration. Although the concentration of the oxygen carrier in the diluent may vary according to the application, it does not usually exceed a concentration of 10 g/dl of Hb. More specifically, the concentration is usually between 0.1 and 8 g/dl Hb.

Suitable aqueous diluents (i.e., those that are pharmaceutically acceptable for intravenous injection) include, inter alia, aqueous solutions of proteins, glycoproteins, polysaccharides, and other colloids. It is not intended that these embodiments be limited to any particular diluent. Consequently, diluents may encompass aqueous cell-free solutions of albumin, other colloids, or other non-oxygen carrying components.

This solution property of a PEG-Hb conjugate is due to the strong interaction between PEG chains and solvent water molecules. This is believed to be an important attribute for an HBOC for two reasons: 1) higher viscosity decreases the diffusion constant of both the PEG-Hb molecule, and 2) higher viscosity increases the shear stress of the solution flowing against the endothelial wall, eliciting the release of vasodilators to counteract vasoconstriction. Accordingly, the formulation of PEG-Hb in the aqueous diluent usually has a viscosity of at least 2 centipoise (cP). More specifically, between 2 and 4 cP, and particularly around 2.5 cP. In other embodiments, the viscosity of the aqueous solution may be 6 cP or greater, but is usually not more than 8 cP.

Administration

A number of tissues and organs may be treated with the Hb-CO complexes of the present invention including kidney, liver, lung, pancreas, heart, intestine and skin. In fact, any tissue or organ having an identifiable blood vessel that supplies oxygenated blood to the organ and a blood vessel that circulates deoxygenated blood from the organ can be treated, by perfusion, suffusion and/or bolus administration, with the Hb-CO complex of the present invention. These tissues and organs may be treated while still intact in the body of the donor, or they may be treated after removal. For example, a donor may be administered Hb-CO via a catheter placed angiographically into the arterial circulation of the organ. If the tissue or organ is later removed from the donor for transplantation, the tissue or organ is treated intra-arterially for the duration of storage. During implantation, the recipient may be infused intravenously and/or intra-arterially with Hb-CO during and following the transplant procedure for example, for up to 48 hours following surgery. For an organ removed from a deceased donor, the organ may be treated intra-arterially before storage or may be perfused or suffused during the period of storage and prior to transplantation. Organs can be harvested from a donor and transplanted by any methods known to those skilled in the art (e.g. Oxford Textbook of Surgery, Morris and malt, Eds. Oxford University press (1994)).

Treatment may be performed utilizing a recirculating or non-recirculating system for introducing the Hb-CO complex into the arterial circulation of the organ. One type of recirculating system is shown in U.S. Pat. No. 7,410,474. In a non-recirculating system the venous effluent is discharged into waste. In either system, the organ may be perfused with Hb-CO alone or with a mixture of CO and O₂ loaded Hb. The amount of carbon monoxide delivered to the organ may range from 1-100% CO saturation of total Hb. Within this range, carbon monoxide initiates a reduction in oxygen demand by the tissue and induces a type of hibernative state that increases storage capability and reduces organ damage. Concentrations of CO and O₂ can be monitored continuously as needed. For example, CO levels in the sub-ppm range can be measured in biological tissue by a mid-infrared gas sensor (Morimoto et al., 2001, Am. J. Physiol. Heart. Circ. Physiol. 280:H482-88A). Both O₂ and CO sensors and gas detection devices are widely available from a number of commercial sources. If the CO drops below desired levels during administration, additional Hb-CO can be administered. In general, Hb-CO is perfused through the blood supply vessels (arteries) of the organ and retrieved through the blood recirculating vessels (veins). These perfusion points will vary depending on the organ, but are well known to those in the art. For example, Hb-CO is perfused into the kidney through the renal artery and retrieved through the renal vein. In the liver, both the portal vein and hepatic artery supply blood to the organ. Consequently, Hb-CO is perfused through both of these vessels and retrieved through the vena cava.

Organ function may be utilized to determine the extent of damage the organ received, if any, during extraction, storage and implantation. These assays will vary depending on the organ being transplanted. For example, monitoring the profile of specific markers such as cytokines, chemokines and receptor levels in the urine of renal transplant patients is a noninvasive way to detect renal damage. These markers include monokines induced by interferon gamma, interferon-inducible protein 10, and osteoprotegerin in urine samples and may be detected using a variety of commercially available assays such as the PlexMark™ 3 Renal Biomarker Panel Assay and Luminex® xMAP® (Invitrogen, San Diego, Calif.). For liver, tests include determining the levels of albumin, alanine transaminase, aspartate transaminase alkaline phosphatase and total bilirubin in the blood. Similar tests to determine the functionality of transplanted organs are known in the art.

### EXAMPLES

### Example 1

### Preparation of a Hemoglobin-Carbon Monoxide Complex

A. Thiolation of Hemoglobin

Packed red blood cells (“RBCs”) are procured from a commercial source, such as from a local Blood Bank, the New York Blood Center, or the American Red Cross. The material is obtained not more than 45 days from the time of collection. All units are screened for viral infection and subjected to nucleic acid testing prior to use. Non-leukodepleted pooled units are leukodepleted by membrane filtration to remove white blood cells. Packed RBCs are pooled into a sterile vessel and stored at 2-15° C. until further processing. The volume is noted, and Hb concentration is determined using a commercially available co-oximeter, or other art-recognized method.

RBCs are washed with six volumes of 0.9% sodium chloride using a 0.45-μm tangential flow filtration, followed by cell lysis by decreasing the concentration of salt. Hb extraction is performed using the same membrane. The cell wash is analyzed to verify removal of plasma components by a spectrophotometric assay for albumin. The lysate is processed through a 0.16-μm membrane in the cold to purify Hb. The purified Hb is collected in a sterile depyrogenated vessel and then ultrafiltered to remove viruses. Additional viral-reduction steps, including solvent/detergent treatment, nanofiltration and anion Q membrane purification, may be performed. All steps in this process are carried out at between 2-15° C.

Hb from lysate is exchanged into Ringer's lactate (“RL”), Ringer's acetate (“RA”) or phosphate-buffered saline (“PBS”), pH 7.4 using a 30-kD membrane. The Hb is concentrated to 1.1-1.5 mM (tetramer). Between 10 to 12 volumes of RL or PBS are used for solvent exchange. This process is carried out at 2-15° C. The pH of the solution prepared in RL is adjusted to 7.0-7.6. The Hb is sterile-filtered through a 0.45 or 0.2-μm disposable filter capsule and stored at 4±2° C. before the chemical modification reaction is performed.

Thiolation is carried out using less than 8-fold molar excess of 2-IT over Hb. This ratio and reaction time were optimized to maximize the number of thiol groups for PEGylation and to minimize product heterogeneity. Approximately 1 mM Hb (tetramer) in RL (pH 7.0-8.5), PBS or any similar buffer was combined with less than 8 mM 2-IT in the same buffer. This mixture was continuously stirred for less than 6 hours at 10±5° C.

B. Conjugation of Hb with MaIPEG

Thiolated Hb is PEGylated with less than a 15-fold molar excess of MaIPEG based on 100% terminal activity over the starting Hb tetramer concentration. The Hb is first allowed to equilibrate with the atmosphere to oxygenate the Hb. Approximately 1 mM thiolated Hb in RL (pH 7.0-8.5), PBS or any similar buffer was combined with less than 16 mM MaIPEG in the same buffer. This mixture was continuously stirred for less than 6 hours at 10±5° C.

PEGylated-Hb is processed through a 70-kD membrane (i.e. a 20-volume filtration) to remove excess unreacted reagents and Hb. This process is monitored by size-exclusion liquid chromatography at 540 nm and 280 nm. The protein concentration is diluted to 4 g/dl and the pH is adjusted to 7.3±0.3 using 1 N NaOH.

The final MaIPEG-Hb product is sterile-filtered using a 0.2-μm sterile disposable capsule and collected into a sterile depyrogenated vessel at 4±2° C.

PEG-Hb is diluted to 4 g/dl RL and the pH adjusted to 7.4±0.2.

The final PEG-Hb is sterile-filtered (0.2-μm) and aliquoted by weight into sterile glass vials. The vials are sealed with sterile rubber stoppers and crimped seals in a laminar flow hood. The vials are then stored at −80° C. until use.

C. Carbon Monoxide Loading of PEGylated Hemoglobin

The PEG-Hb is equilibrated with a desired concentration of CO in a chamber containing a prescribed concentration of CO.

### Example 2

### Preservation of an Organ

The function of an organ for transplant is often compromised by a series of events during the time leading to harvest, during harvest, storage, transplantation and following transplantation. The administration of Hb-CO during any of these events increases the survival of the organ in the recipient.

Administration of Hb-CO can be performed at any time during the process from pre-harvest to post-transplantation. This includes administration to the donor, to the isolated organ, and to the recipient. Administration to the donor or to the recipient is performed by intravenous infusion of Hb-CO at a rate to achieve total blood CO-hemoglobin saturation between 1-30% of total hemoglobin in the blood. Administration to an organ ex vivo may be by any method or rate that achieves a concentration of Hb-CO between 1-100% of total hemoglobin. Infusion of the organ, either in situ or ex vivo, may be with Hb-CO alone or in combination with other fluids, which are typically used in surgical or transplant procedures. Other fluids include, but are not limited to blood, crystalloid, colloid, and Hb-Oₓ. In addition, other pharmaceuticals considered standard of care in such procedures may be included, such as anti-oxidants, anti-inflammatory agents, vasodilators, vasoconstrictors and anesthetic agents.

Administration of Hb-CO to the organ donor occurs at about 24 hours prior to harvest. The volume and rate of administration is regulated to achieve a CO-hemoglobin saturation of between 1-30% of total Hb. Temperature of the solution infused is between room temperature and 38° C.

Administration of Hb-CO to the organ recipient occurs at about 24 hours prior to transplant and 168 hours (7 days) after organ transplantation. The volume and rate of administration is regulated to achieve a CO-hemoglobin saturation of between 1-30% of total Hb in the blood. Temperature of the solution infused is between room temperature and 38° C.

Administration of the Hb-CO ex vivo is performed using an extracorporeal perfusion apparatus. The apparatus may consist of a reservoir of Hb-CO, a heat exchanger for cooling or warming the perfusion fluid, a gas exchanger for oxygenation or carboxylation of the gas, a flow meter and pressure transducer for measurement of flow and pressure of the solution, cannulae for accessing the vascular system of the organ for perfusion of the arterial (and portal) vessels, and collection of the solution from the venous outflow. The perfusion apparatus may also contain an organ bag for storage of the organ and access ports for sampling the fluid entering or exiting the organ. In addition to perfusion of the fluid through the vascular system of the organ, the perfusion circuit would allow for superfusion of the organ (i.e. bathing of the organ in Hb-CO to optimize exposure of the surface of the organ). The perfusion circuit may be either a recirculating or a non-recirculating system.

Functional assessment of the transplanted organ in the recipient is performed according to standard clinical techniques for evaluation of organ function. For example, evaluation of transplanted kidney function would include measurement of blood urine nitrogen (“BUN”) and creatinine, glomerular filtration rate, renal plasma flow, urine concentrating ability, fractional sodium excretion and biomarkers of renal tubular damage (e.g. N-acetyl glucosaminidase, β-2 microglobulin and glutathione-S transferase). Histologic assessment of tissue biopsies may also be performed where appropriate.

### Example 3

### Perfusion of an Organ

Perfusion of an organ is performed with a perfusion apparatus, such as, for example, an exsanguinous metabolic support system. The perfusion apparatus is comprised of a perfusion path through which the perfusion solution enters (arterial access) and exits (venous access) the preserved organ, a pump, heat exchanger and temperature sensor/controller, an oxygenator, and sensors to measure perfusion pressure, pH, oxygen tension and carbon dioxide tension both proximal and distal to the perfused organ. Sampling ports generally are present on the arterial and venous sides of the perfusion circuit for sampling and measurement of oxygen content and other parameters, e.g. glucose concentration.

The perfusion solution can be of variable composition but, optimally, will resemble that described in US2010-0316705, and includes hemoglobin as an oxygen carrier and carbon monoxide carrier. The pH, hemoglobin concentration, oxygen content and carbon monoxide content ismonitored and adjusted accordingly by control of carbon dioxide and oxygen flow to the oxygenator, and periodic exchange of the perfusion solution to optimize concentration of hemoglobin, carbon monoxide and other metabolites. The exact composition of the perfusion solution will vary depending on the type of organ being perfused, but is easily optimized using routine experimentation.

Organs that are perfused in this manner are first isolated from the donor and sufficient perfusion fluid injected slowly into the arterial circulation to clear the organ of blood. The arterial and venous vessels are then cannulated, the organ placed into the perfusion apparatus and the circulation begun to maintain a predetermined perfusion pressure or perfusate flow by regulation of pump speed. Perfusate temperature will vary depending on the organ perfused, but will generally be maintained constant between 23-38° C. Perfusion will last between 30 minutes to 96 hours, and organ function and metabolism will be monitored by vascular parameters (blood flow, perfusion pressure), oxygen consumption, glucose or fatty acid utilization, lactate uptake/production, changes in organ weight, cell signaling molecules indicative of therapeutic benefit (kinases, transcription factors, apoptotic markers), histologic analysis of tissue biopsies, biomarkers indicative of specific organ dysfunction, e.g. cytokines, troponin, etc.

In this manner, organs can be tested for functional integrity, predictive of outcome following transplant into the recipient. Once the organ is selected for transplant into the recipient, final functional measurements are assessed, the perfusion is discontinued, cannulae removed and the organ delivered to the transplant team for implantation into the recipient. Function of the organ post-transplantation is assessed according to standard clinical practice and correlated with pre-implant data obtained during ex vivo perfusion.

The examples set forth above are provided to give those of ordinary skill in the art a complete disclosure and description of how to make and use the preferred embodiments of the compositions, and are not intended to limit the scope of what the inventors regard as their invention. Modifications of the above-described modes (for carrying out the invention that are obvious to persons of skill in the art) are intended to be within the scope of the following claims. All publications, patents, and patent applications cited in this specification are incorporated herein by reference as if each such publication, patent or patent application were specifically and individually indicated to be incorporated herein by reference.

We claim:

1. A method of preserving a tissue or organ for transplantation comprising the steps of:
a) providing a hemoglobin-carbon monoxide (Hb-CO) complex;
b) selecting a tissue or organ for transplantation; and
c) treating the tissue or organ with the Hb-CO complex.

2. The method according to claim 1, wherein step c) further comprises treating the tissue or organ ex vivo.

3. The method according to claim 1, wherein step c) further comprises treating the tissue or organ in situ.

4. The method according to claim 1, wherein treating the tissue or organ with the Hb-CO complex comprises perfusing the tissue or organ with the Hb-CO complex.

5. The method according to claim 1, wherein treating the tissue or organ with the Hb-CO complex comprises suffusing the tissue or organ with the Hb-CO complex.

6. The method according to claim 1, wherein treating the tissue or organ with the Hb-CO complex comprises bolus administration to the tissue or organ with the Hb-CO complex.

7. The method according to claim 1, wherein treating the tissue or organ with the Hb-CO complex further comprises a combination of perfusion, suffusion or bolus administration to the tissue or organ with the Hb-CO complex.

8. The method according to claim 1, wherein the hemoglobin of the Hb-CO complex further comprises a pegylated hemoglobin conjugate.

9. The method according to claim 8, wherein the pegylated hemoglobin conjugate further comprises maleimide polyethylene glycol conjugated hemoglobin (MaIPEG-Hb),

10. The method according to claim 1, wherein the tissue or organ is selected from the group consisting of kidney, liver, lung, pancreas, heart, intestine and skin.
